(19) United States
(12) Patent Application Publication
(10) Pub. No.: US 2006/0117909 A1
(43) Pub. Date: Jun. 8, 2006

(54) Tire-patching apparatus

(76) Inventor: Ching-Sen Hsu, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/007,440

(22) Filed: Dec. 8, 2004

(51) Int. Cl. B29C 73/08

(52) U.S. Cl. 81/15.6; 152/370; 156/97

(57) ABSTRACT

A tire-patching apparatus is disclosed for patching a tire. The tire-patching apparatus includes a container and a nozzle extended from the container. The container is used for containing glue. The nozzle is used for spraying glue into a cut in the tire from the container. A plug may be provided in addition. The plug includes a space defined therein and a plurality of apertures communicated with the space. The plug can be forced into the cut in the tire. Glue can be sprayed into the space of the plug from the container through the nozzle. Glue can flows into the cut from the space of the plug through the apertures of the plug.

### BACKGROUND OF INVENTION

1. Field of Invention

The present invention relates to a tire-patching apparatus.

2. Related Prior Art

Taiwanese Publication No. 509141 shows a conventional tire-patching apparatus with a handle 11 and a needle 12 extending from the handle 110. The needle 20 is formed with a point 21, a plurality of threads (such as these indicated by “31”, “32”, “33” and “34”) near the point 21 and a notch 22 defined therein near the threads. In use, a rubber band 40 is put in the notch 22. The rubber band 40 is dipped in glue. The point 21 is inserted in a cut (not numbered) in a tire T. The threads are driven through the cut. Accordingly, the portion of the needle 20 in which the notch 22 is defined is inserted into the cut so that the rubber band 40 is brought into the cut, folded. The needle 20 is pulled from the tire T. Because of the notch 22, the rubber band 40 is left in the cut. Because of the glue, the rubber band is adhered to the tire T, i.e., the tire T is patched. The cut is inevitably enlarged while the threads are driven into the tire T. i.e., the tire T is further damaged before it gets patched.

In an alternative manner, the tire T is removed from a rim (not shown). The internal side of the tire T around the cut is grounded. A flat patch (not shown) can be adhered to the internal side of the tire T around the cut. Thus, the tire T is patched. It is however troublesome to remove the tire T from the rim. Moreover, the internal side of the tire T is grounded, i.e., the tire T is further damaged before it gets patched.

The present invention is therefore intended to obviate or at least alleviate the problems encountered in prior art.

### SUMMARY OF INVENTION

According to the present invention, a tire-patching apparatus is disclosed for patching a tire. The tire-patching apparatus includes a container and a nozzle extended from the container. The container is used for containing glue. The nozzle is used for spraying glue into a cut in the tire from the container.

The primary advantage tire-patching apparatus according to the present invention is that it does not further damage the tire.

Other objects, advantages and novel features of the invention will become more apparent from the following detailed description in conjunction with the attached drawings.

### BRIEF DESCRIPTION OF DRAWINGS

The present invention will be described via detailed illustration of embodiments referring to the drawings.

FIG. 1 is a side view of a tire and a tire-patching apparatus according to a first embodiment of the present invention.

FIG. 2 is an enlarged view of the tire-patching apparatus shown in FIG. 1.

FIG. 3 is similar to FIG. 2 but shows the tire-patching apparatus in a different position relative to the tire.

FIG. 4 is similar to FIG. 3 but shows the tire-patching apparatus in a different position relative to the tire.

FIG. 5 shows a portion of a tire in a cross-sectional view and a tire-patching apparatus according to a second embodiment of the present invention in a side view.

FIG. 6 shows a portion of a tire in a cross-sectional view and a tire-patching apparatus according to a third embodiment of the present invention in a side view.

FIG. 7 is similar to FIG. 6 but shows the tire-patching apparatus in a different position relative to the tire.

FIG. 8 shows a portion of a tire and a portion of a tire-patching apparatus according to a fourth embodiment of the present invention in a cross-sectional view and the remaining portion of the tire-patching apparatus in a side view.

FIG. 9 is similar to FIG. 8 but shows glue sprayed from the tire-patching apparatus.

FIG. 10 shows a portion of a tire and a portion of a tire-patching apparatus according to a fifth embodiment of the present invention in a cross-sectional view and the remaining portion of the tire-patching apparatus in a side view.

FIG. 11 is similar to FIG. 10 but shows glue sprayed from the tire-patching apparatus.

### DETAILED DESCRIPTION OF EMBODIMENTS

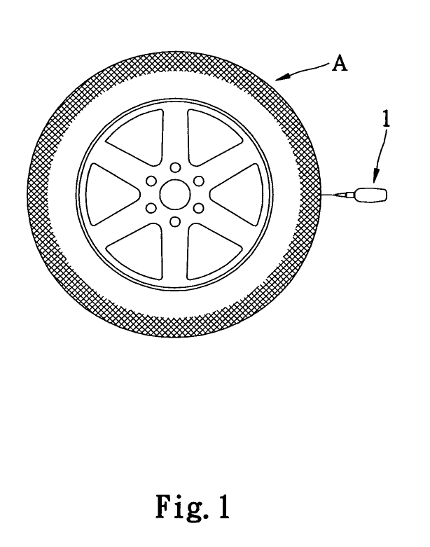

FIG. 1 shows a tire-patching apparatus 1 according to a first embodiment of the present invention.

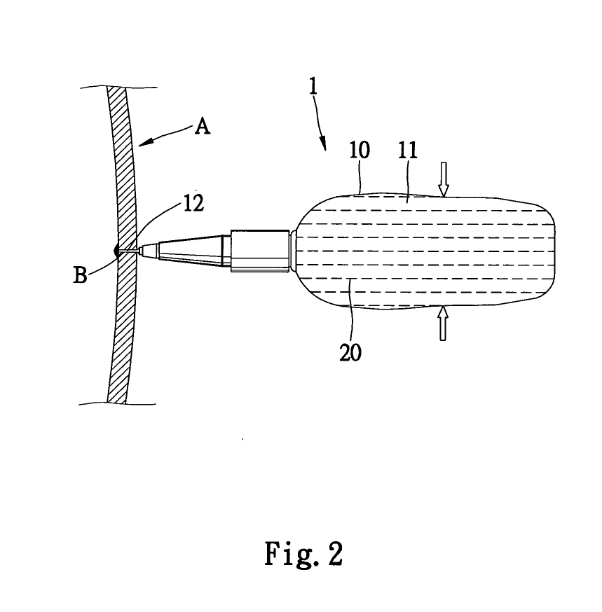

Referring to FIG. 2, the tire-patching apparatus 1 includes a flexible container 10 and a nozzle 12 extended from the container 10. The container 10 contains glue 20. The container 10 is flexible or elastic and can be squeezed so that the glue 20 is sprayed from the container 10 through the nozzle 12. The nozzle 20 is in the form of a needle.

In use, the nozzle 12 is inserted through a cut B in the tire A. The tip of the nozzle 12 is located near the internal side of the tire A. The container 10 is squeezed so that some glue 20 is sprayed onto the internal side of the tire A. The nozzle 12 is kept in that position for a while so that the glue 20 cures and blocks the cut B.

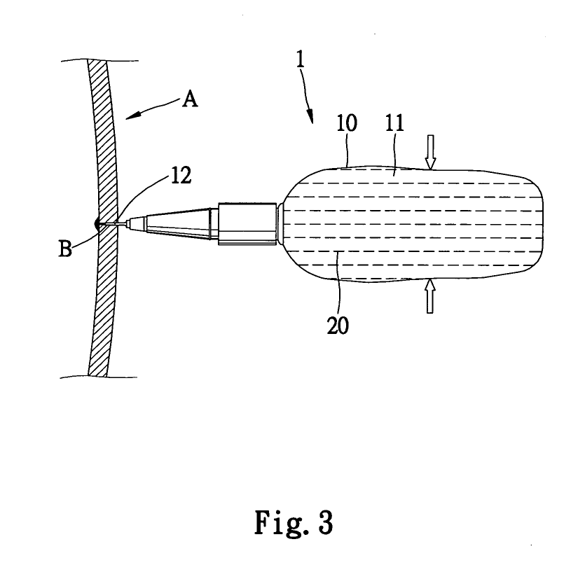

Referring to FIG. 3, while the nozzle 12 is moved along the cut B, the container 10 is squeezed so that more glue 20 is sprayed into the cut B.

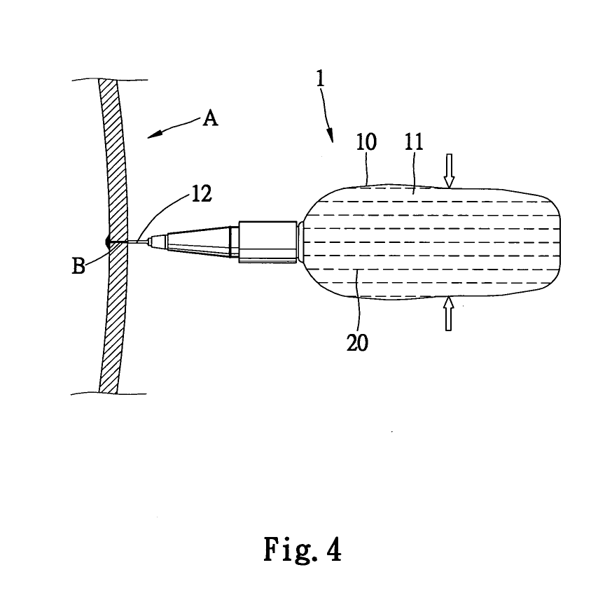

Referring to FIG. 4, by the time when the nozzle 12 is moved out of the cut B, the cut B has been filled with glue 20.

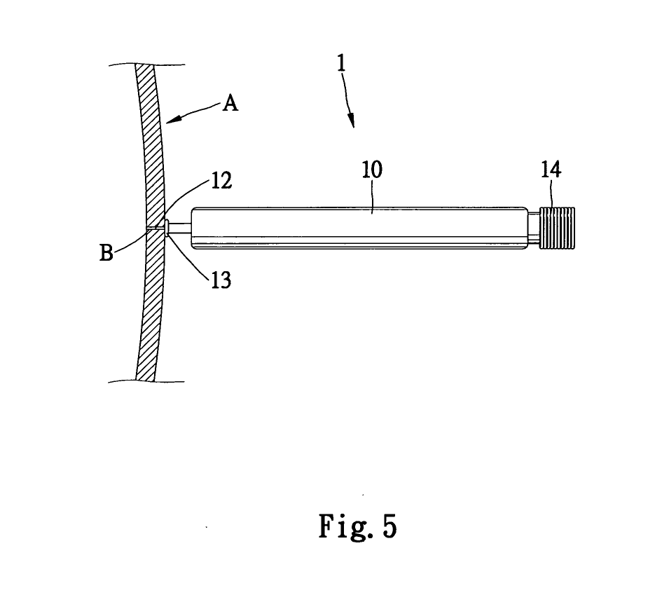

FIG. 5 shows a tire-patching apparatus 1 according to a second embodiment of the present invention. The second embodiment is identical to the first embodiment except for a few things. Firstly, a rigid container 10 is used instead of the flexible or elastic container 10. Secondly, a press portion 14 is connected with the rigid container 10. The press portion 14 can be pressed in order to spray glue 20 from the rigid container 10. Thirdly, a restraint 13 is provided on the nozzle 12 so that the nozzle 12 will not be inserted too deep into the tire A.

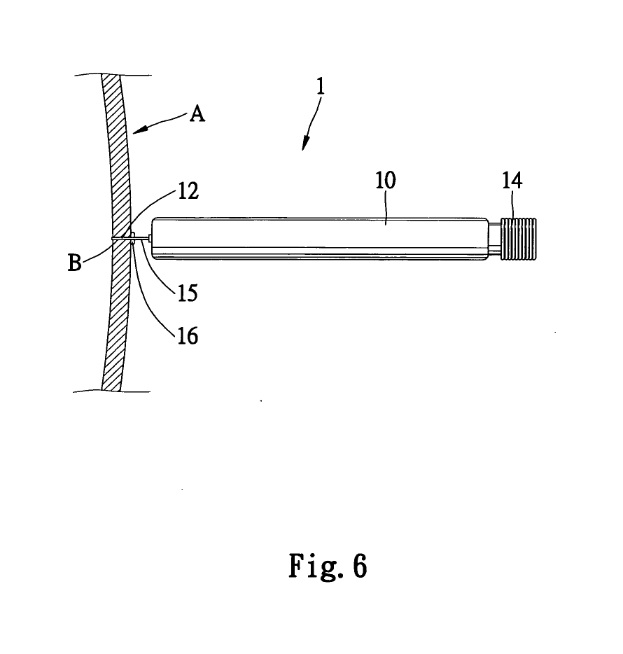

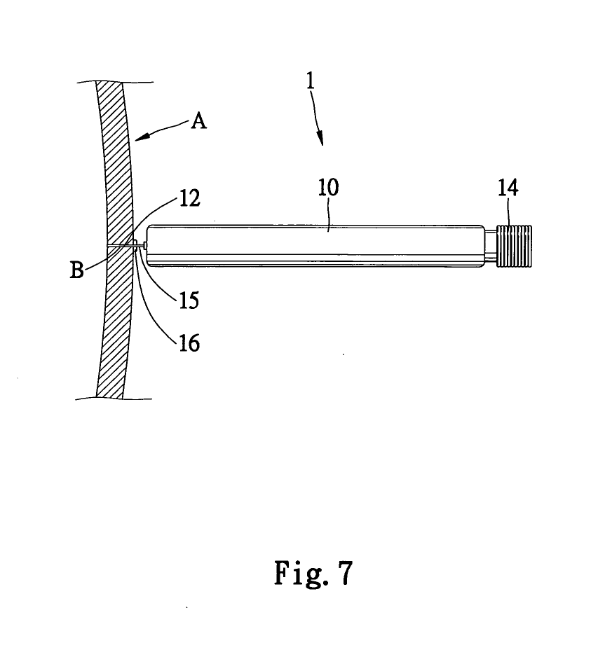

FIGS. 6 and 7 show a tire-patching apparatus 1 according to a third embodiment of the present invention. The third embodiment is identical to the second embodiment except for a few things. Firstly, a nut 16 with a thread is used instead of the restraint 13. Secondly, a thread 15 is formed on the nozzle 12 for engagement with the thread of the nut 16. Thus, the length of the nozzle 12 that will be inserted into the cut B can be changed according to the thickness of the tire.

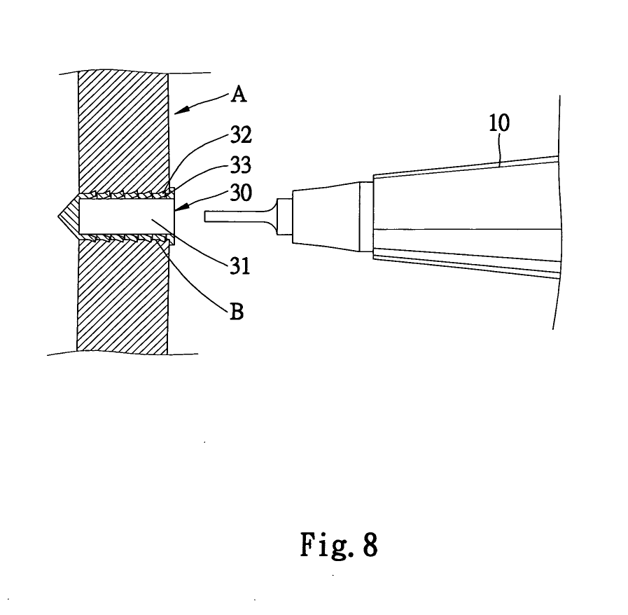

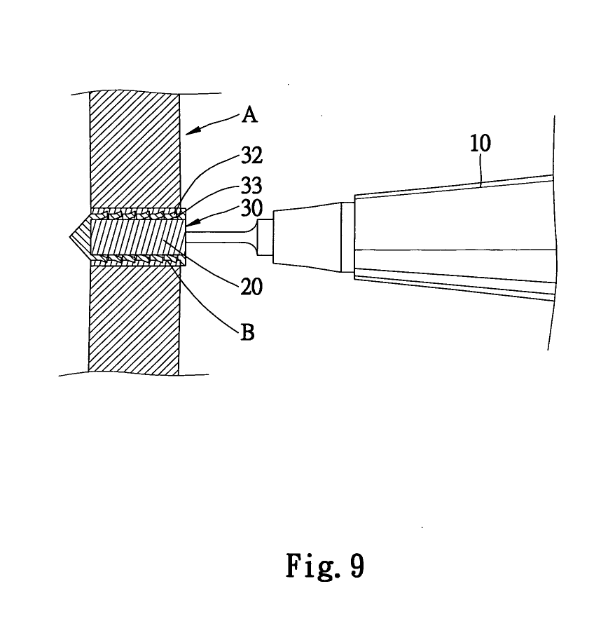

FIGS. 8 and 9 show a tire-patching apparatus 1 according to a fourth embodiment of the present invention. The fourth embodiment is identical to the first embodiment except for including a plug 30. The plug 30 includes a space 31 defined therein, a plurality of apertures 33 communicated with the space 31 and a plurality of anchors 32 formed on the external side of the plug 30. In use, the plug 30 is forced into the cut B. Glue 20 is fed into the space 31. Then, glue 20 flows into the apertures 33 from the space 31. Finally, glue 20 flows into the cut B from the apertures 33.

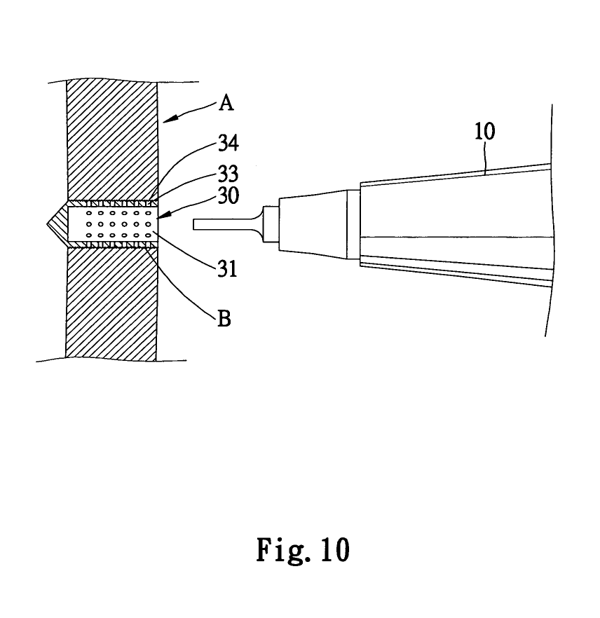

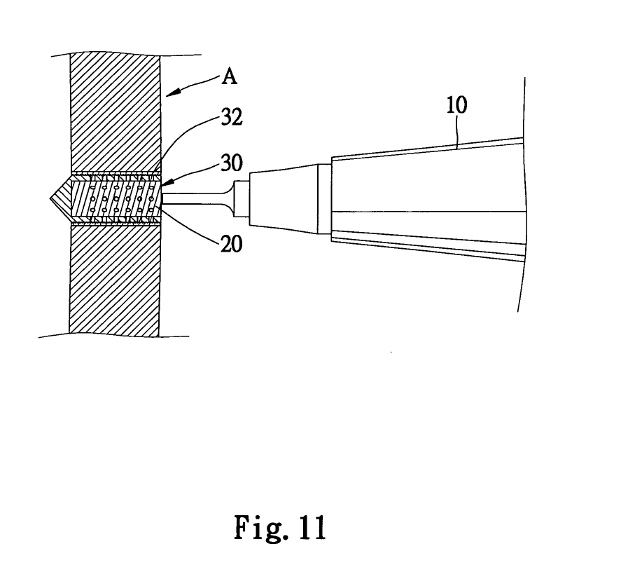

FIGS. 10 and 11 show a tire-patching apparatus 1 according to a fifth embodiment of the present invention. The fifth embodiment is identical to the fourth embodiment except for including a thread 34 instead of the anchors 32.

The present invention has been described via detailed illustration of some embodiments. Those skilled in the art can derive variations from the embodiments without departing from the scope of the present invention. Therefore, the embodiments shall not limit the scope of the present invention defined in the claims.

What is claimed is:

1. A tire-patching apparatus comprising a container for containing glue and a nozzle for spraying glue into a cut in a tire from the container.

2. The tire-patching apparatus according to claim 1 wherein the container is flexible.

3. The tire-patching apparatus according to claim 1 wherein the container is elastic.

4. The tire-patching apparatus according to claim 1 wherein the container is rigid.

5. The tire-patching apparatus according to claim 4 comprising a press portion connected with the container, wherein the press portion can be squeezed in order to spray the glue from the container.

6. The tire-patching apparatus according to claim 1 comprising a restraint formed on the nozzle for preventing insertion of the nozzle too deep into the cut.

7. The tire-patching apparatus according to claim 1 comprising a restraint installed on the nozzle for preventing insertion of the nozzle too deep into the cut.

8. The tire-patching apparatus according to claim 7 wherein the restraint is movably installed on the nozzle.

9. The tire-patching apparatus according to claim 8 wherein the nozzle comprises a thread formed thereon, wherein the restraint is in the form of a nut with a thread engaged with the thread of the nozzle.

10. A tire-patching apparatus comprising:
a plug for insertion into a cut in a tire, wherein the plug comprises a space defined therein and a plurality of apertures communicated with the space;
a container for containing glue; and
a nozzle for spraying glue into the space of the plug from the container.

11. The tire-patching apparatus according to claim 10 wherein the container is flexible.

12. The tire-patching apparatus according to claim 10 wherein the container is elastic.

13. The tire-patching apparatus according to claim 10 wherein the container is rigid.

14. The tire-patching apparatus according to claim 13 comprising a press portion connected with the container, wherein the press portion can be squeezed in order to spray the glue from the container.

15. The tire-patching apparatus according to claim 10 wherein the plug comprises a plurality of anchors formed thereon for firm engagement with the tire.

16. The tire-patching apparatus according to claim 10 wherein the plug comprises a thread formed thereon for firm engagement with the tire.

17. A tire-patching plug for insertion into a cut in a tire, wherein the plug comprises a space defined therein for receiving glue and a plurality of apertures communicated with the space so that glue can be fed into the cut from the space through the apertures.

18. The tire-patching plug according to claim 17 comprising a plurality of anchors formed thereon for firm engagement with the tire.

19. The tire-patching plug according to claim 17 comprising a thread formed thereon for firm engagement with the tire.
